(19) United States
(12) Patent Application Publication
(10) Pub. No.: US 2024/0151536 A1
(43) Pub. Date: May 9, 2024

(54) STRUCTURE ALARM

(71) Applicant: Rory Korathu-Larson, LLC, Seattle, WA (US)

(72) Inventor: Rory Korathu-Larson, Seattle, WA (US)

(21) Appl. No.: 18/386,967

(22) Filed: Nov. 3, 2023

Related U.S. Application Data
(60) Provisional application No. 63/422,318, filed on Nov. 3, 2022.

(51) Int. Cl. G01C 21/16; G08B 21/18

(52) U.S. Cl. CPC G01C 21/16; G08B 21/18

(57) ABSTRACT

A structure alarm for sensing a change of status in the structure comprises an insert having a magnetic field, an encasing material encasing the insert, and a base attached to the encasing material and comprising a sensing assembly. Changes in the magnetic field correspond to changes in the status of the structure, and the sensing assembly is an inertial measurement unit that is adapted to send a signal corresponding to the changes in the magnetic field of the insert.

This patent application claims priority benefit of U.S. provisional patent application 63/422,318, filed on Nov. 3, 2022.

### FIELD OF THE INVENTION

This invention relates to structure alarms, and more particularly to pressure sensors suitable for measuring damage to an object.

### BACKGROUND OF THE INVENTION

Structures such as bridges, roads, as well as large mobile structures such as tanks, ships, and satellites, as well as smaller structures such as body armor, may suffer damage. It is important for those responsible for such structures to be able to assess changes in the status of such structures as soon as practical, especially when the change of status is damage to that structure.

Known techniques for addressing these kinds of issues can include visual inspection, which can be expensive and is not always practical where there are many such structures to be evaluated (such as a series of bridges) or the structure is in a remote location (such as outer space), as would be the case for satellites. It would therefore be desirable to provide a structure alarm that can provide detailed and useful data about the status of a structure to those responsible for such structures.

### SUMMARY OF THE INVENTION

In accordance with a first aspect, a structure alarm for sensing a change of status in the structure comprises an insert having a magnetic field, an encasing material encasing the insert, and a base attached to the encasing material and comprising a sensing assembly. Changes in the magnetic field correspond to changes in the status of the structure, and the sensing assembly is an inertial measurement unit that is adapted to send a signal corresponding to the changes in the magnetic field of the insert.

In accordance with another aspect, a method for measuring a change of status in a structure comprises the steps of (1) providing a structure alarm for sensing a change of status in a structure that comprises an insert having a magnetic field, an encasing material encasing the insert, and a base attached to the encasing material and comprising a sensing assembly comprising an inertial measurement unit; and (2) disposing the structure alarm on or integrated with the structure; wherein the inertial measurement unit measures and sends a signal corresponding to the change in the magnetic field of the insert, and wherein the change in the magnetic field corresponds to the change in the status of the structure.

From the foregoing disclosure and the following more detailed description of various embodiments, it will be apparent to those skilled in the art that the present invention provides a significant advance in the technology of structure alarms. Particularly significant in this regard is the potential the invention affords for providing a reliable, dependable, and easy-to-use pressure sensor for ascertaining load and indicating damage to an object such as buildings, bridges, satellites, and military equipment. Additional elements and advantages of various embodiments will be better understood in view of the detailed description provided below.

### BRIEF DESCRIPTION OF THE DRAWINGS

FIG. 1 is a schematic isometric view of a structure alarm in accordance with one embodiment.

FIG. 2 is a schematic of a bridge with a series of structure alarms placed support columns of the bridge.

FIG. 3 is a schematic showing how damage to one of the structure alarms sends a signal to alert a user to the damage.

It should be understood that the appended drawings are not necessarily to scale, presenting a somewhat simplified representation of various features illustrative of the basic principles of the invention. The specific design features of the structure alarm as disclosed here, including, for example, the specific dimensions of the insert will be determined in part by the particular intended application and use environment. Certain features of the illustrated embodiments have been enlarged or distorted relative to others to help provide a clear understanding. In particular, thin features may be thickened, for example, for clarity of illustration. All references to direction and position, unless otherwise indicated, refer to the orientation illustrated in the drawings.

### DETAILED DESCRIPTION OF CERTAIN EMBODIMENTS

It will be apparent to those skilled in the art, that is, to those who have knowledge or experience in this area of technology, that many uses and design variations are possible for the structure alarm disclosed here. The following detailed discussion of various alternate elements and embodiments will illustrate the general principles of the invention with reference to a structure alarm suitable for use with bridges, military equipment, ships, and satellites. Other embodiments suitable for other applications will be apparent to those skilled in the art given the benefit of this disclosure.

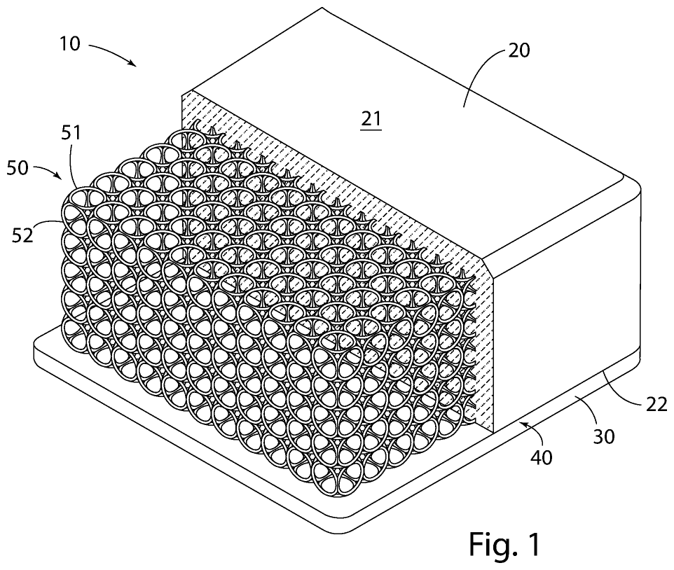

Turning now to the drawings, FIG. 1 shows a schematic example of a structure alarm 10. The structure alarm may advantageously be formed as a modular assembly such as a tile or node, and a series of such tiles/nodes may be applied to each structure as needed. The structure alarm 10 may be fully integrated into a structure while the structure is built or manufactured. The structure alarm 10 may also be added to a structure after such structure is built or manufactured. The structure itself can comprise, for example, a bridge or a portion of a highway, movable structures such as a tank, a ship, or body armor, for example. The structure alarm 10 has an encasing material 20 an insert 50 and a base 30. The encasing material 20 defines a show surface 21 and a bottom surface 22 opposite the show surface, an insert 50 positioned in the encasing material between the show surface and the bottom surface, with the insert having a magnetic field, In one embodiment, encasing material 20 encloses insert 50. The encasing material 20 can have one of several different geometries, such as substantially cuboid or cube-like, or “pizza saver” shaped with a base and three legs, with each leg acting as an offset probe.

Insert 50 comprises at least a core material 51 and at least an exterior material 52 and is configured to have a magnetic field. Insert 50 can have many different geometries. For example, insert 50 can have a cuboid (3D rectangle) geometry, or a hollowed out cuboid, or a cuboid shape with legs, etc.

In one embodiment, the insert may be lattice-shaped, with the core material 51 formed as a series of crossing beams defining a honeycomb-like structure, and is coated by the exterior material 52 comprising a coating of RF paint. In yet another embodiment, the lattice-shaped structure can have Schwarz-P minimal surfaces. In mathematics, a minimal surface is a surface that locally minimizes its area. This is equivalent to having zero mean curvature. The term minimal surface is used because these surfaces originally arose as surfaces that minimized total surface area subject to some constraint. However, Schwarz-P minimal surfaces are understood here to refer to more general surfaces that may self-intersect or do not have constraints. Exemplary Schwarz-P minimal surfaces include the honeycomb-like geometry of the insert of FIG. 1. For a given constraint, there may also exist several minimal surfaces with different areas, and may only relate to a local optimum, not a global optimum.

The core material 51 can comprise a moldable polymer, for example. Such polymeric materials can comprise, for example, polyethylene, polypropylene, polystyrene, polyvinyl chloride, synthetic rubber, phenol formaldehyde resin (or Bakelite), neoprene, nylon, polyacrylonitrile, PVB, or silicones. For example, the core material can be a cured SLA resin (405 nm UV resin) for example. The exterior material 52 may comprise a magnetic material including, but not limited to, a radio frequency (“RF”) paint or coating. Such RF paint or coating typically comprises nickel flakes to provide shielding to help reduce electromagnetic field (EMF) and RF frequencies, as well as shielding electromagnetic radiation (“EMR”) radiation, including Wi-Fi and 5G. The insert 50 can be made via one of several methods. For example, the insert 50 can be made via insert injection molding techniques or can be made using a 3-D printer, depending upon the intended application.

Encasing material 20 comprises a show surface 21 and a bottom surface 22. In one embodiment, the bottom surface 22 is on the opposite position relative to the show surface 21. Encasing material 20 comprises a material selected from the group consisting of one or more ceramic materials, one or more polymers, and combinations thereof. One or more polymers may be used when the environment is less harsh, and the structure alarm can be assembled using an injection molding process. Alternatively, or in addition to polymers, one or more robust ceramic materials may be used. For example, a more robust ceramic may be used such as when the structure is a satellite. For more standard conditions the encasing material 20 can be made via standard insert injection molding techniques and/or can be made using a 3-D printer, depending upon the intended application.

Base 30 may comprise a material selected from the group consisting of one or more ceramic materials, one or more polymers, and combinations thereof. Base 30 can further comprise a sensing assembly 40. An example of a sensing assembly 40 includes, but is not limited to, an inertial measurement unit. Such an inertial measurement unit is adapted to measure and send a signal corresponding to the change in the magnetic field of insert 50. In one embodiment, such change in the magnetic field corresponds to the change in the status of the structure, such as a bridge.

In one embodiment, base 30 is removably attached to the encasing material 20. In another embodiment, the encasing material 20 is attached/fixedly secured to the base 30 at the bottom surface 22. Optionally, the inertial measurement unit may be encapsulated or largely surrounded by the base 30 and may also be physically separated from the insert 50.

The structure alarm 10 may be formed as a modular assembly such as a tile or node, and a series of such tiles/nodes may be applied to each structure as needed. The magnetic field of the insert 50 varies with a change in a status of the structure relative to the structure's predetermined state. For example, this change of status can be due to a change in pressure or compression applied to the structure, ablation, damage, or percentage damage to the structure, for example, relative to an initial predetermined point of reference. Changes in the magnetic field of the insert 50 correspond to changes in the status of the structure relative to an initial point of reference.

The structure itself can comprise, for example, a bridge or a portion of a highway; or, movable structures such as a tank, a ship, or body armor, for example. In practice, the structure alarm 10 for sensing a change of status in a structure is disposed on or within a structure, wherein sensing assembly 40 (for example, an inertial measurement unit) measures and sends a signal corresponding to the change in the magnetic field of the insert 50 corresponding to one or more changes in the status of the structure, for examples, changes in pressure or compression applied to the structure, ablation, damage, or percentage damage to the structure relative to an initial point of reference. In one embodiment, such change in the magnetic field corresponds to the change in the status of the structure, such as a bridge.

The magnetic field of insert 50 varies with a change in a status (i.e., changes in pressure or compression applied to the structure, ablation, damage, or percentage damage to the structure relative to an initial point of reference) of the structure. The magnetic field of the insert varies with a change in a status of the structure. This change of status can be pressure/compression applied to the structure, ablation, damage, or percentage damage to the structure, for example. Changes in the magnetic field of the insert 50 correspond to changes in the status of the structure, and the sensing assembly is an inertial measurement unit that is adapted to send a signal corresponding to the changes in the magnetic field of the insert. The generated signal may be relayed to a display such that real-time data about the structure in question can be known and also recorded, optionally remotely from the structure. Advantageously, this can give operators rapid notice of failures and potential failures, with the ability to initiate repairs, road closures, etc., when the structure is a bridge. Optionally as a way of conserving power, no signal may be sent unless there is a change in the status of the structure.

The sensing assembly 40 may further comprise a controller (microcontroller) to process a signal received and send it on. The controller may be part of the sensing assembly 40 and included in an inertial measurement unit. The signal may be processed with a 3-axis magnetic field meter, for example. The inertial measurement unit can optionally comprise a magnetometer, or a gyroscope, or a compass and powered by an uninterrupted power supply. Induction sensors may also be used to indicate damage. A suitable inertial measurement unit is the MinIMU-9 v5 Gyro, Accelerometer, and Compass (LSM6DS33 and LIS3MDL Carrier). Also, the controller may be remote from the rest of the structure alarm. Other sensing assemblies suitable for use in the structure alarm will be readily apparent to those skilled in the art given the benefit of this disclosure.

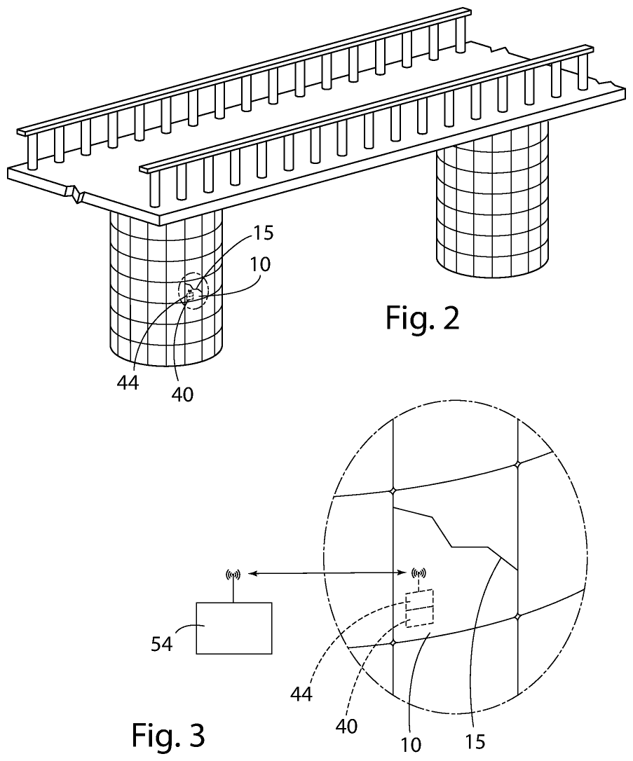

FIG. 2 shows an embodiment where the structure is a bridge and a series of structure alarms 10 are placed on support columns of the bridge. One of the structure alarms is damaged (see crack 15), and this results in a signal being sensed by inertial measurement unit 40 and sent via controller 44 to indicate the extent of such damage. FIG. 3 shows a schematic with controller 44 operatively connected to the inertial measurement unit 40 and sending a signal to another controller 54 remote from the rest of the structure alarm, preferably a wireless signal. Either controller can process the wireless signal so that critical information about the crack 15 of the particular structural alarm 10 may be displayed on a display, and typically the display is remote from the structure/structural unit.

From the foregoing disclosure and detailed description of certain embodiments, it will be apparent that various modifications, additions, and other alternative embodiments are possible without departing from the true scope of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A structure alarm for sensing a change of a status in the structure comprising, in combination:
an insert having a magnetic field;
an encasing material encasing the insert; and
a base attached to the encasing material and comprising a sensing assembly;
wherein a change in the magnetic field of the insert corresponds to the change in the status of the structure, the sensing assembly is an inertial measurement unit and is adapted to send a signal corresponding to the change in the magnetic field of the insert.

2. The structure alarm of claim 1 wherein the insert comprises a core material and a magnetic material.

3. The structure alarm of claim 2 wherein the insert is lattice-shaped.

4. The structure alarm of claim 3 wherein the magnetic material is radio frequency paint.

5. The structure alarm of claim 4 wherein the encasing material defines a show surface and a bottom surface opposite the show surface, and the base is attached to the bottom surface.

6. The structure alarm of claim 5 wherein the lattice is a matrix having Schwarz-P minimal surfaces.

7. The structure alarm of claim 1 wherein sensing assembly further comprises a controller and the inertial measurement unit is positioned in the base and physically separated from the insert.

8. The structure alarm of claim 1 wherein the encasing material comprises one of a ceramic, a plastic, and combinations thereof.

9. The structure alarm of claim 1 wherein the inertial measurement unit further comprises a gyroscope and an accelerometer.

10. The structure alarm of claim 1 wherein the insert has a core and a radio frequency paint covers the core, and the insert is a cuboid.

11. The structure of claim 1 wherein the encasing material consists essentially of a ceramic and the structure is one of a bridge and a satellite.
